(19) United States
(12) Patent Application Publication
(10) Pub. No.: US 2013/0057148 A1
(43) Pub. Date: Mar. 7, 2013

(54) INSTRUMENT ARRANGEMENT FOR A MOTOR VEHICLE

(71) Applicant: Peter Schneiker, Ruesselsheim (DE)

(72) Inventor: Peter Schneiker, Ruesselsheim (DE)

(73) Assignee: GM GLOBAL TECHNOLOGY OPERATIONS LLC, Detroit, MI (US)

(21) Appl. No.: 13/597,719

(22) Filed: Aug. 29, 2012

(30) Foreign Application Priority Data
Sep. 2, 2011 (DE) 10 2011 112 261.7

(51) Int. Cl. B60Q 3/04

(52) U.S. Cl. 315/77

(57) ABSTRACT

An instrument arrangement for a motor vehicle is provided. The instrument arrangement has an instrument, an instrument lighting for lighting the instrument, and an on-board computer. The on-board computer is configured to make available a settings menu, in which the brightness of the instrument lighting can be set, and at least one further different menu, in which another function can be set.

### CROSS-REFERENCE TO RELATED APPLICATION

This application claims priority to German Patent Application No. 10 2011 112 261.7, filed Sep. 2, 2011, which is incorporated herein by reference in its entirety.

### TECHNICAL FIELD

The technical field relates to an instrument arrangement for a motor vehicle, in particular a passenger vehicle, having at least one instrument, an instrument lighting for lighting this instrument, and a setting means for setting a brightness of this instrument lighting, as well as to a method for setting a brightness of an instrument lighting of such an instrument arrangement.

### BACKGROUND

Instrument panel lightings that light display instruments, such as a tachometer, speedometer, temperature displays and the like, as well as actuation elements such as light switches, air-conditioning switches, radio switches and the like, are known for example from DE 10 2005 001 532 A1. The brightness of such instrument panel lightings can be changed or set in order to take into account different ambient conditions, driver wishes and the like. To this end, a designated switch is normally provided on the instrument panel. This disadvantageously increases cost and limits the driver's control panel.

DE 10 2005 001 532 A1 therefore proposes allocating a number of functions to a mechanical actuation element already provided in the instrument panel of the motor vehicle, wherein one allocation is then used to set the brightness of the instrument panel lightings. As examples, DE 10 2005 001 532 A1 cites a switch for activating rear screen heating, a button for setting a clock, and a reset button for resetting a daily kilometre counter.

It has not been considered in that case that the brightness of an instrument lighting is generally only very rarely adjusted. A multiple allocation of functions to a directly accessible mechanical switch then involves occupation of the allocation assigned to brightness setting, in particular a degree of freedom of the switch, so that said switch is no longer available for other settings which are used more frequently, for example adaptation of cruise control, intermittent operation of windscreen wipers, or the like. In addition, the number of allocations and therefore the complexity of the operation are detrimental to comfort.

On the other hand, on-board computers are known per se, which have different menus in which different functions can be set. For example, known on-board computers have a menu, which allows the setting of entertainment functions, for example selection of a radio station, setting of volume, and the like, as well as a further menu, in which a navigation function can be set, for example a target can be input.

At least one object herein is to improve the setting of brightness of instrument lighting. In particular but not exclusively, “brightness” is understood to be a radiation measure, in particular a radiation energy W [J], a radiation flow Φe [W], an irradiation He [J/m²], an irradiation intensity Ee [W/m²] or the like, or a photometric measure, in particular an amount of light Q [lm s], a luminous flux Φ[lm], an exposure lx s], a lighting intensity E [lx], a luminous intensity I [cd], a luminous emittance M [lm/m²] or a luminous density L [cd/m²], and “setting” is understood in particular to mean the setting, in particular pre-setting and possibly conversion, of a target value for control or regulation of the instrument lighting. In addition, other objects, desirable features and characteristics will become apparent from the subsequent summary and detailed description, and the appended claims, taken in conjunction with the accompanying drawings and this background.

### SUMMARY

One embodiment herein proposes the setting of the brightness of an instrument lighting in a menu, in particular a sub-menu arranged in a lower position of a hierarchy, of an on-board computer. Allocations, in particular degrees of freedom, of directly accessible actuation elements, such as light, indicator and cruise control switches, can thus be used for other, more frequently used settings. This is based on the knowledge that the brightness of the instrument lighting is changed rarely by a driver, and it is therefore acceptable to provide the initially relatively complex setting thereof in a menu, in particular a sub-menu, of an on-board computer.

Such an optimisation with consideration of the outlay, in particular the time and/or operational outlay, for the setting of the instrument lighting brightness and also of another function is even more advantageous if, in an embodiment, two or more different set brightnesses can be stored in a personalised manner. In the present case, this is understood to mean that a specifically set brightness is assigned to a specific person and stored in this manner. If the on-board computer then recognises, for example on the basis of a personalised identification card, an electronic ignition key, a visual and/or acoustic driver identification, the input of a person-specific code or the like, that the driver is this specific person, the stored brightness assigned to this person is automatically set.

In addition or as an alternative, such an initially relatively complex setting in a menu of an on-board computer can be more advantageous if, in an embodiment, the set brightness is automatically adapted according to an ambient parameter. In particular, an ambient parameter may include an ambient brightness, a time of day and/or the fact that the driver is wearing sunglasses.

Particularly if the set brightness is stored in a personalised manner and, when the driver is detected as being this person, is automatically set and/or the set brightness is automatically adapted according to an ambient parameter, the need to set the brightness is reduced to a minimum for any driver, and is ideally reduced to a one-time setting or the unchanging adoption of default or pre-set values.

In an embodiment contemplated herein, the brightness of one or more instrument lightings for lighting each instrument or a plurality of instruments of an instrument arrangement for a motor vehicle, in particular a passenger vehicle, is set in a settings menu of an on-board computer, which, in addition to this settings menu, also has one or more further menus in which one or more other functions can be set. Such other functions may include, for example, a navigation function, a communication function, in particular video calling, a vehicle information function, in particular a display of vehicle parameters on a screen of the on-board computer, an air-conditioning function and/or an entertainment function, for example an audio or video system. For example, navigation targets of a navigation system, telephone numbers of a car telephone, target values for an air-conditioning system or vehicle heating system, song titles, stations, volumes and/or other audio parameters and the like can thus be input in further menus of the on-board computer. In the present case, a pre-setting or changing of a parameter of a function is generally referred to as a setting of this function in order to provide a more compact illustration.

In another embodiment a settable starting value is predefined for the setting of the brightness of the instrument lighting in the settings menu. A default value for the brightness can thus be easily predefined for different countries with different ambient conditions for example, and can be retained if the operator does not change this value, although the operator can also quickly set a suitable, individual brightness starting from this default value. For example, it may therefore be advantageous to predefine a lower brightness than the starting value for a country with continuous daylight, so that, in this country, the operator does not have to adjust the instrument lighting brightness or at any rate does not have to adjust it much, from a high brightness, which is less suitable for instrument lighting during daytime.

In addition or as an alternative, in an embodiment for setting the brightness of the instrument lighting, a starting value can be predefined in the settings menu, which is dependent on an ambient parameter, for example one of the aforementioned ambient parameters of ambient brightness, time of day and the wearing of sunglasses. For example, the starting value can thus be raised if the ambient brightness falls or if it is a time of day at which ambient brightness is low. Starting from such an adapted starting value, the operator can leave the brightness of the instrument lighting unchanged or, starting from such an adapted starting value, can quickly set a suitable, individual brightness.

In a further embodiment, the settings menu has a lower position in the hierarchy than one or more further menus. If, as has already been explained, the brightness is rarely changed, the setting in a lower position in the hierarchy can keep free higher positions in the hierarchy for more frequently used settings. A low position in the hierarchy is understood in the present case to mean a position in the hierarchy, for example a sub-menu, which is reached in more steps than a higher position in the hierarchy.

In an embodiment an instrument is an analogue or digital display instrument, in particular a round instrument. In an embodiment, such an instrument comprises a vehicle speed, engine speed, fill level, and/or temperature display. In another embodiment, in addition or as an alternative, at least one instrument may comprise an actuation element which is lit, for example a backlit switch, an illuminated switch, or the like. In a further embodiment, in addition or as an alternative, at least one instrument may comprise a display and/or an operating part, which is lit, for example of a navigation unit, a communication unit, an air-conditioning unit or an entertainment device, such as an audio system.

In an embodiment the instrument lighting for backlighting the instrument is formed from a side remote from the driver. In addition or as an alternative, the instrument lighting can be designed to illuminate the instrument, in particular from the edge of a round instrument or actuation element.

In an exemplary embodiment, an instrument panel of a passenger vehicle has an analogue round instrument for displaying speed, a further analogue round instrument for displaying an engine speed, an analogue round instrument for displaying an engine and coolant temperature, a further analogue round instrument for displaying a fuel and oil fill level, and a plurality of switches for actuating window lifters, adjusting outside mirrors, and the like. All of these instruments are illuminated by a plurality of LEDs of a common instrument lighting when a headlight and/or an interior light of the passenger vehicle is/are activated. Equally, individual instruments can also be assigned different individually settable instrument lightings.

The brightness of this/these instrument lighting(s) is initially set by an on-board computer to a value that, for example during configuration or supply, is predefined in a corresponding menu of the on-board computer. The brightness adapts automatically to an ambient brightness, which is detected by an ambient brightness sensor, directly or indirectly on the basis of a time of day of an on-board computer.

If a driver wishes to change this default value, for example because the brightness is not sufficient for him or is too excessive, he selects, for example by actuating a touchscreen, a multi-function setting means such as a rotatable push-button, a switch on an indicator control arm, or the like, a settings menu of the on-board computer, which to this end in an embodiment can display corresponding information, selection options, default or setting values, or the like on a screen. In this menu, the operator sets the desired brightness by corresponding actuation of the touchscreen, multi-function setting means, switch, or the like. This is set by corresponding control of the instrument lighting(s) and is also stored automatically and assigned to the operator, for example since he is allocated an identification number, which the on-board computer has assigned to the operator on the basis of an identification card, an electronic key, or the like.

When the on-board computer recognises this operator on the basis of the identification card, the electronic key, or the like in the event of subsequent use of the vehicle, it automatically sets the stored brightness again.

Within the context herein, an on-board computer may include in particular one or more distributed processor, storage, input and/or output means, such as a keyboard, a screen and in particular a touchscreen. In this regard, a designated authority that controls the brightness of an instrument lighting and communicates with a computer that makes available one or more navigation, communication, vehicle information, air-conditioning and/or entertainment functions, may also form part of an on-board computer within the meaning herein.

### BRIEF DESCRIPTION OF THE DRAWINGS

The various embodiments herein will hereinafter be described in conjunction with the following drawing figures, wherein like numerals denote like elements, and wherein:

FIG. 1 is a method for setting a brightness of an instrument lighting of an instrument arrangement according to an exemplary embodiment; and

FIG. 2 is an instrument arrangement according to an exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

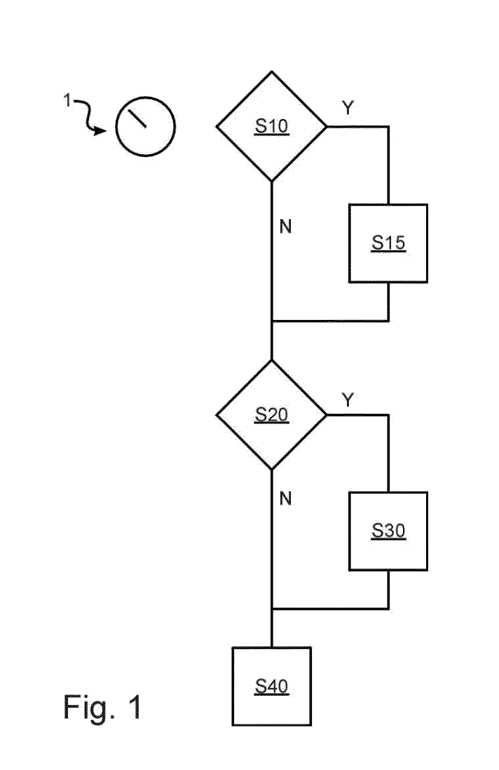

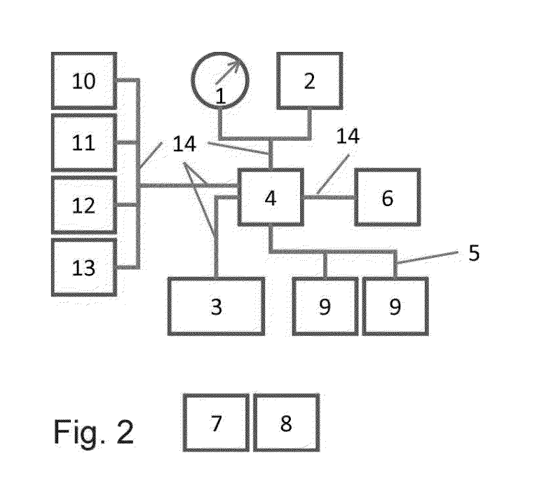

FIG. 1 shows a method for setting a brightness of an instrument lighting of an instrument arrangement in accordance with an exemplary embodiment. The instrument arrangement, which will be explained in greater detail hereinafter with reference to FIG. 2, in particular comprises a round instrument 1 for displaying speed. The instrument lighting 9 (see FIG. 2) for backlighting the instrument 1 is formed on a side remote from the driver (not illustrated).

In a first method step S10, it is determined, for example on the basis of a coded ignition key 7 or 8 (see FIG. 2), whether a personalised brightness has been stored for the driver identified by the coded ignition key. If this is the case (S10: “Y”), this is set in a step S15, otherwise (S10: “N”) a default or starting value for the brightness is retained.

If the driver wishes to change the brightness, he selects, for example by actuating an operator unit 6 (see FIG. 2) a corresponding sub-program or sub-menu in a step S20 in an on-board computer main menu (S20: “Y”). He can thus set a brightness in a step S30, in particular change a starting value, and can store this for example by actuating the selection. This starting value is predefined for example in a country-specific manner, wherein different starting values can be set for different countries. In addition or as an alternative, the starting value can be predefined independently of ambient parameters, such as an ambient brightness and/or time of day.

At this point, in an embodiment, the on-board computer 4 (see FIG. 2) returns to a subordinate menu, in particular the main menu, in which it remains if there is no selection of the sub-program menu to set the brightness (S20: “N”). The stored, personalised brightness is automatically set during subsequent journeys when the driver is recognised on the basis of a coded ignition key 7, 8 (S10: “Y”).

The current brightness, that is to say the stored, personalised brightness or the default or starting value, is automatically adapted in a step S40 according to ambient parameters, such as an ambient brightness and/or time of day.

In a modification, the brightness is set and stored independently of the driver in a sub-menu of the on-board computer main menu (steps S20, S30). When the vehicle is started, the stored brightness is then set independently of the respective driver.

FIG. 2 shows an instrument arrangement in accordance with an embodiment herein with the analogue or digital round instrument 1, which is connected to an on-board computer 4 via a BUS line 14.

The on-board computer 4 is connected via further bus lines 14 to backlit switches, of which one switch 2 is illustrated by way of example in FIG. 2, a display 3 for displaying on-board computer menus, an operator unit 6, for example a multi-functional lever, a touchscreen (which may be identical to the display 3), a selecting rotary push-button or the like, an operator part of a navigation unit 10, an operator part of a communication unit 11, an operator part of an air-conditioning unit 12 and an operator part of an entertainment device, for example of an audio system 13.

The on-board computer is connected via a cable 5 to a plurality of illumination means 9, for example LEDs, and controls the brightness thereof. Individual illumination means 9 are assigned to the various, aforementioned instruments.

The round instrument 1, the switch 2, the display 3, the navigation unit 10, the communication unit 11, the operator part of an air-conditioning unit 12 and the audio system 13 each constitute instruments within the meaning herein that can be lit by an instrument lighting in the form of the illumination means 9 in a manner controlled by the on-board computer 4.

FIG. 2 further shows, by way of example, two radio keys 7, 8 with different personalised codings.

The on-board computer 4 is designed to carry out the above-described method explained with reference to FIG. 1 to set a brightness of an instrument lighting of an instrument arrangement. The brightnesses of the illumination means 9, which are assigned to the further instruments 2, 3, 10 to 13, can be set in the same manner as described previously by way of example for the round instrument 1. A basic brightness value is preferably set for all instrument lightings, wherein the brightnesses of individual illumination means 9 are set on the basis of this basic brightness value. For example, the brightness of the round instrument 1 may thus be 1.5 times the basic brightness value, whereas by contrast the brightness of the operator part of the air-conditioning unit 12 may only be the same as the basic brightness value so as to light the round instrument 1 primarily. Equally, it is also possible to set different brightnesses for individual instruments or groups of instruments or to set the same brightness for all instruments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A method for setting a brightness of an instrument lighting of an instrument arrangement, the method comprising the step of:
setting a brightness of the instrument lighting in one of a plurality of menus of an on-board computer of the instrument arrangement.

2. The method according to claim 1, wherein at least two different set brightnesses are stored in a personalised manner.

3. The method according to claim 1, wherein a settable starting value and/or a starting value dependent on an ambient parameter is predefined for the brightness.

4. The method according to claim 1, wherein the brightness is automatically adapted according to an ambient parameter.

5. An instrument arrangement for a motor vehicle comprising:
an instrument; an instrument lighting for lighting the instrument; an on-board computer that is configured to make available a settings menu, in which the brightness of the instrument lighting can be set; and a further different menu in which another function can be set.

6. The instrument arrangement according to claim 5, wherein the settings menu is arranged in a lower position in a hierarchy than the further menu.

7. The instrument arrangement according to claim 5, wherein at least two different set brightnesses can be stored in a personalised manner in the on-board computer.

8. The instrument arrangement according to claim 5, wherein the instrument is an analogue or digital display instrument, in particular a round instrument.

9. The instrument arrangement according to claim 9, wherein the instrument comprises a vehicle speed, engine speed, fill level and/or temperature display.

10. The instrument arrangement according to claim 5, wherein the instrument comprises an actuation element.

11. The instrument arrangement according to claim 5, wherein the instrument lighting is configured to backlight and/or illuminate the instrument.

12. The instrument arrangement according to claim 5, wherein another function includes a navigation, communication, vehicle information, air-conditioning and/or entertainment function.

13. The instrument arrangement of claim 5, wherein the motor vehicle is a passenger vehicle.
